(19) United States
(12) Patent Application Publication
(10) Pub. No.: US 2007/0297728 A1
(43) Pub. Date: Dec. 27, 2007

(54) ANTI-REFLECTIVE OPTICAL FILM

(75) Inventor: Andrey Nikolaevich PUTILIN, Moscow (RU)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Gyeonggi-do (KR)

(21) Appl. No.: 11/758,142

(22) Filed: Jun. 5, 2007

(30) Foreign Application Priority Data
Jun. 7, 2006 (RU) 2006119965

(51) Int. Cl. G02B 6/36

(52) U.S. Cl. 385/94

(57) ABSTRACT

An anti-reflective optical film is provided. The anti-reflective optical film includes a file of optical elements. Each of the optical elements includes: a first planar surface and a second smoothly curved surface having a full internal reflection (FIR) and extending from the first planar surface to form a curved elongated shape. The first planar surface receives an entrance light that exits an area of the second smoothly curved surface.

This application claims priority to Russian Patent Application No. 2006-119965, filed on Jun. 7, 2006 and all the benefits accruing therefrom under 35 U.S.C. §119, and the contents of which in its entirety are herein incorporated by reference.

### BACKGROUND OF THE INVENTION

1. Field of the Invention

The present invention relates generally to optics, and more particularly, to anti-reflective optical films for use in liquid crystal displays (“LCDs”), plasma displays, projection television screens, solar cells, and optical sensors.

2. Description of the Related Art

Display surfaces, such as those used in LCDs, are generally coated using an antireflective, antiglare coating material which depresses the amplitude of an exterior reflected light from the display screen caused by interferential phenomena, thereby magnifying the contrast of the displayed image. These coatings also are applied in the production of cathode-ray tubes (“CRTs”) and plasma displays.

Optical films having a low exponent of refraction, are also used for diminution of reflection due to reduction of Fresnel reflections at the interface of optical medium. The antireflective film coatings, e.g., consist of a supporting layer, a layer with a low exponent of a refractive on the basis of fluorite gums, and an antiglare layer disposed between them (see, for example, U.S. Pat. No. 6,888,593 [1]). Such films provide for diminution of reflection of light and improvement of the passage of light from a modulator LCD to the observer of the device that results in greater contrast of the observable image.

Another known method of reducing the influence of external illumination on the displayed image (see, for example, U.S. Pat. No. 6,388,372 [2]) consists of an optical element in which a relief layer is created thereon. Another solution provides an optical antiglare film as described in U.S. Pat. No. 6,992,827 [3]. However, this solution as well as the aforementioned solutions are known to have drawbacks, such as low optical transmission and rather significant deformations of the image observable on the display, especially when viewed at greater angles with respect to the normal viewing angle of the display.

### BRIEF SUMMARY OF THE INVENTION

Exemplary embodiments of the present invention provide an antireflective optical film that enables light from a modulator of light to effectively pass therethrough while simultaneously suppressing patches of light from external light sources, and also to provide a wide angle view of the display to an observer.

An exemplary embodiment of the present invention includes a file of optical elements, each of the optical elements including a first planar surface, and a second smoothly curved surface having a full internal reflection (FIR) and extending from the first planar surface to form a curved elongated shape. The first planar surface receives an entrance light that exits an area of the second smoothly curved surface.

The second smoothly curved surface may be a combination of several smooth surfaces. The optical elements may range in size from 20 micrometers to 200 micrometers. The second surface may have an axis of symmetry intersecting the first and second surfaces at unique points.

The second smoothly curved surface may have at least one symmetry plane intersecting the first and second surfaces.

Each of the optical elements may include a third planar surface disposed at an opposite end of the optical element from the first planar surface. The first planar surface and the third planar surface may extend in the same direction and in parallel with one another.

The first and third surfaces may have a circular shape when viewed from a planar surface thereof.

A diameter of the third surface may be smaller than a diameter of the first surface.

The refraction factor of a substance from which the optical elements are made may be within a range of 1 to 1.95.

A top portion of the second smoothly curved second surface has a surface relief implemented by at least one of a periodic wave, a sine wave, or triangular wave and texturized to have a size within a range of 0.1 microns to 0.2 microns.

The surface relief may have a noise-like character.

A shape of the first planar surface may be at least one of round, triangular, rectangular, and hexagonal.

The second smoothly curved surface may have fractal structure at which low spatial frequencies work as elements on full internal reflection, and high spatial frequencies work as antireflective, antiglare layers.

The optical elements may be disposed on a plane of the optical film and range in size with respect to a height thereof.

The optical elements may be disposed on a plane of the optical film and are of equal size with respect to a height thereof.

The optical elements may be disposed on a plane of the optical film and vary in size with respect to a cross-section thereof.

The optical elements may be disposed on a plane of the optical film and are of equal size with respect to a cross-section thereof.

The optical elements may be disposed on a plane of the optical film and vary in size with respect to a cross-section thereof and a height thereof.

The second smoothly curved surface may be partially coated with a low refractive-index layer.

The optical elements may be made of an optical substance having a gradient of refractive index along the direction of distribution of light from the first planar surface to the second smoothly curved surface within the range of 2.0 to 1.0.

The second smoothly curved surface may be partially coated by multilayered interference antireflective covering.

A substance, from which the optical elements are made, may have polarizing properties.

When used in an LCD, the increase of the angle of review without deformations of chromaticity and contrast is provided.

### BRIEF DESCRIPTION OF THE DRAWINGS

The above and/or other aspects, features, and advantages of the present invention will become apparent and more readily appreciated from the following description of the exemplary embodiments, taken in conjunction with the accompanying drawings of which:

FIG. 1 depicts a side view of an optical element used in an optical film in accordance with an exemplary embodiment of the present invention;

FIG. 2 depicts a side view of an optical element used in an optical film in accordance with another exemplary embodiment of the present invention;

FIG. 3 depicts a side view of a file of optical elements used in an optical film in accordance with an exemplary embodiment of the present invention;

FIG. 4 is a perspective view of an exemplary optical film in accordance with an exemplary embodiment of the present invention;

FIG. 5 is a top plan view of a pattern of optical elements in an exemplary embodiment of the present invention;

FIG. 6 is a top plan view of a pattern of optical elements in another exemplary embodiment of the present invention; and

FIG. 7 is a photograph of an optical film including a portion thereof covered with exemplary optical elements.

### DETAILED DESCRIPTION OF THE INVENTION

Reference will now be made in detail to exemplary embodiments of the present invention, examples of which are illustrated in the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art.

A same reference number is allocated to a same element for different embodiments. The same element may be representatively explained only in a first embodiment and omitted in subsequent embodiments.

If a first film (layer) or element is ‘on’ a second film (layer) or element, third films (layers) or elements may be interposed between the first and the second films (layers) or elements or the first and the second films (layers) or elements may contact directly. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

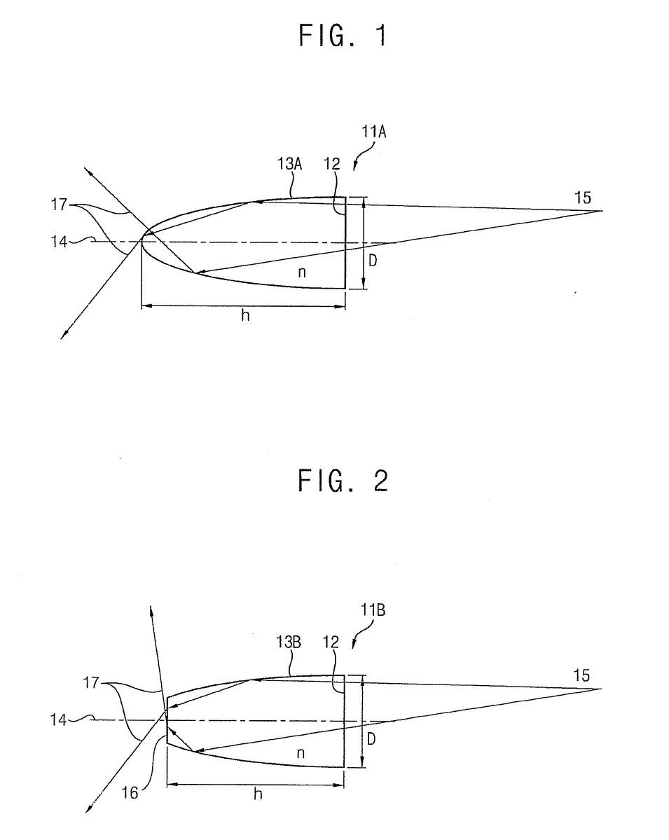

Turning now to FIG. 1, an exemplary embodiment of an optical element used in an optical film will now be described. The optical element 11A is shown in a side view and includes a first surface 12 and a second surface 13A. First surface 12 may be circular in shape when viewed from a planar edge thereof. The second surface 13A has an elongated and smoothly curved surface. In an exemplary embodiment, the optical element 11A has factor of refraction n, absorption constant, and height h. The height of element 11A may be within a range of about 40 microns to about 200 microns; that is, a distance from the first surface 12 to a portion of the second surface 13A furthest away from the first surface 12. The diameter of the element 11A at its widest cross-section may be within the range of about 20 microns to about 100 microns. The size of the diameter may be determined based upon the size of the aperture of a modulator of light from which light beams are transmitted and received at the element 11A. Element 11A includes an axis of symmetry 14 that extends lengthwise at the midsection of the element 11A when viewed from a side view as shown in FIG. 1. Surface 12 serves as an entrance surface for beams 15 transmitted from the modulator of light (not shown). The dimensions of second surface 13A may be determined by a trace of beams applied to an optical model, which is then optimized to generate, by means of effect of full internal reflection (FIR), a demanded band of the review for the observer.

Turning now to FIG. 2, an alternative exemplary optical element 11B will now be described. The optical element 11B includes similar features as those shown and described in FIG. 1, and to this extent, will not be further described. As shown in FIG. 2, an optical element 11B includes first surface 12, a second surface 13B, and a third surface 16. From a side view of the optical element 11B, first surface 12 and third surface 16 extend in the same direction and in parallel with one another. First and third surfaces 12 and 16, respectively, may have a circular shape when viewed from a planar surface thereof. Third surface 16 may be smaller in diameter than the surface 12.

As shown in FIGS. 1 and 2, an entrance light 15 is received from a modulator of light (not shown) at the first surface 12 and an exit light 17 of a given angle is emitted through the second or third surface 13A, 16 based upon, e.g., the distance of the entrance light source, the diameter, surface configuration, and height of the optical element.

The second surface 13A-13B of elements 11A-11B may have at least one symmetry plane intersecting the first 12 and second 13A-13B surfaces thereof.

In an exemplary embodiment, the factor of refraction n of a substance from which the optical film is executed is within the range of 1 to 1.95.

While the shape of the first surface of optical elements 11A and 11B has been described as being circular, it will be understood that the embodiments are not so limited. For example, the first surface 12 may have a triangular shape, rectangular shape, or hexagonal shape.

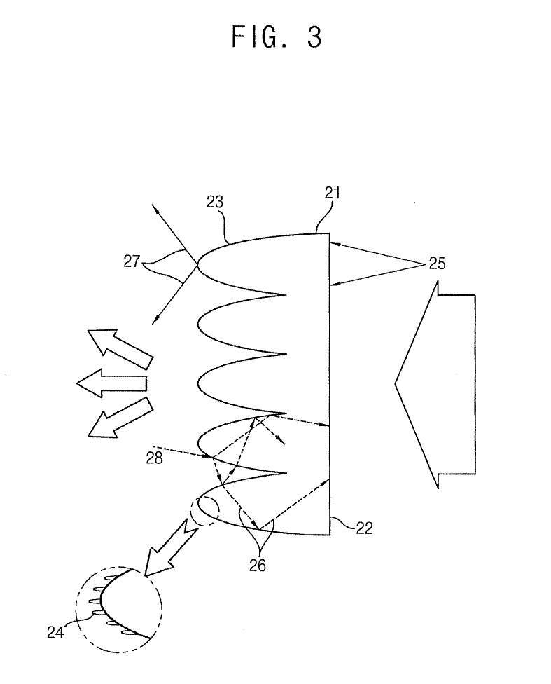

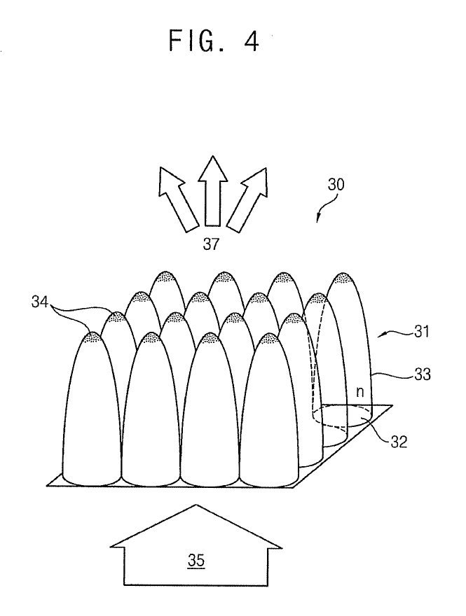

Turning now to FIG. 3, a file of optical elements will now be described in accordance with an exemplary embodiment. The file of optical elements 21 includes a first surface 22 and a second surface 23. The first surface 22 may extend from a first end of the file to a second end of the file of optical elements 21 disposed thereon. The optical elements 21 are exposed to light 25 transmitted from the modulator of light (for example, from a liquid crystal layer in case of an LCD), and the light exiting the elements 21 form a scattered field 23 of observation resulting in a comfortable viewing image formed on the associated display. An antireflective relief 24 provided on the top end of the elements 21, the shape of surface 23 of FIR, and the absorption capabilities enabled by a substance of elements 21, light 27is reflected from an external surface of elements 21, is suppressed and reflected inward toward the optical elements 21 (light 26) and, in relation to external illumination 28, the antiglare and antireflective effects are achieved. Relief 24 of the top portions of optical elements 21 may be implemented, for example, by periodic, sine wave, or triangular in section, and with roughnesses or texturing having a size within a range of about 0.1 microns to about 0.2 microns. The relief may also have a noise-like character, e.g., a chaotic structure with local variation of the amplitude and the period, but with average parameters within the above-stated range.

Turning now to FIG. 4, a perspective view of an optical film including optical elements will now be described in accordance with an exemplary embodiment. As shown in FIG. 4, for purposes of illustration, optical elements have a curved shape with respect to a second surface thereof (e.g., as shown in the embodiment depicted in FIG. 1). Optical elements 31 of the film 30 effectively guide (direct) entrance light 32, entering from the first surface 12, to the opposite end of the element 31. The relief 34 on the second surface 13A enables generation of the preset indicatrix of emanations.

The arrangement of elements 31 as disposed on the film 30 may be either regular or irregular when viewed from a plane view of the film 30 for the greatest density of occupancy of an entrance plane. For example, a plurality of elements 31 having first surfaces with various diameters, such as about 20 microns and 70 microns, and with an identical longitudinal size (i.e., height h) such that intervals between the larger elements (i.e., those having a greater diameter), are densely filled with smaller elements (i.e., those having a smaller diameter).

In another exemplary embodiment, the arrangement of elements 31 as disposed on film 30 may be such that the elements 31 each have a first surface of an identical diameter to the other elements 31, but the elements 31 have varying heights, e.g., in the range of about 50 microns to about 100 microns. Further, it is possible to use an optical file with varying sized elements, which are each determined by a calculated average value (i.e., the longitudinal and cross-sectional sizes are considered simultaneously) in order to achieve a casual distribution of a shaped light field. In particular, the scattering of the sizes and outlines of the surface may have fractal character.

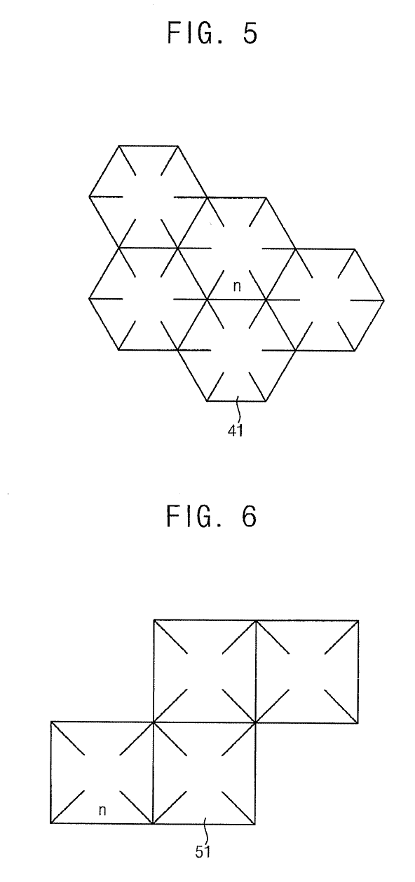

Turning now to FIGS. 5 and 6, a file of optical elements having different planar surface shapes will now be described. In FIG. 5, a top plan view illustrates optical elements 51, each of which has a hexagonal first surface. In FIG. 6, a top plan view illustrates optical elements 61, each of which has a rectangular first surface.

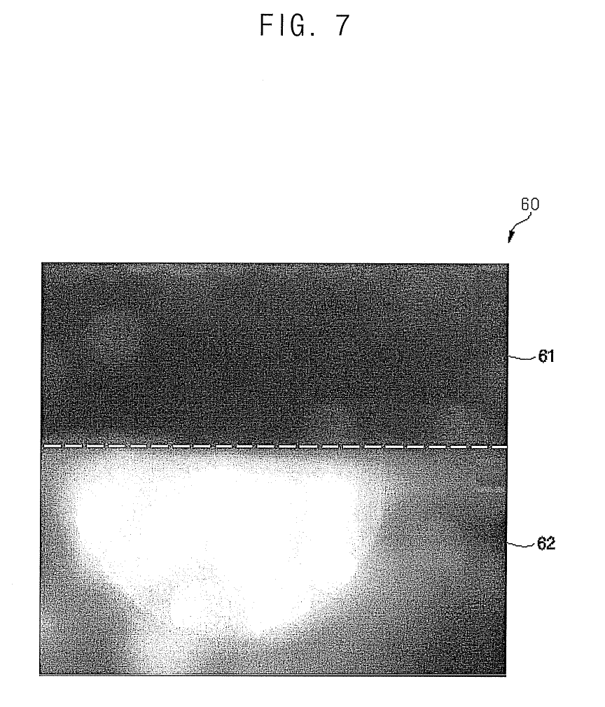

Turning now to FIG. 7, a photograph illustrating an optical film and elements will now be described in exemplary embodiments. As shown in FIG. 7, an optical film 60 formed of, e.g., a polymethylmethacrylate (“PMMA”), and from which light from a light-emitting diode lantern is reflected, is shown. The photograph of FIG. 7 illustrates a top surface of the optical film 60. The film 60 includes a portion 61 that is coated by a file of optical elements (e.g., a file of optical elements as depicted in FIGS. 1-6), and a portion 62 is not coated by antireflective coverings (i.e., optical elements) and is flat.

The second surface of the optical film with the file of elements may be coated with a low refraction index layer.

The optical film 60 may be made of an optical substance having a gradient of refractive index along the direction of distribution of light from the first surface 12 to the second surface 13A-13B within the range of about 2.0 to about 1.0.

The second surface 13A-13B of the optical film may be partially coated by multilayered interference antireflective covering.

The optical film may be made of an optical substance which has polarizing properties.

The following example illustrates performance properties of the optical element 11A shown in FIG. 1.

### EXAMPLE 1

The optical film consisting of a file of rectangular focusing elements, having refraction factor of 1.59, the ratio of height h of the focusing element to the cross-sectional size (i.e., diameter) being equal to two, the angle between a tangent to surface 13A and plane 12 in the base of the element 11A is equal to 83 degrees, and the antireflective covering is calculated for visible white light. The angular aperture of entrance emanation is up to ±35 degrees.

### EXAMPLE 2

The optical film consisting of a file of rectangular focusing elements with a truncated top (i.e., surface 16), having refraction factor of 1.59, the ratio of height h of the focusing element to the cross-sectional size (i.e., diameter) being equal to two, an angle between a tangent to surface 13B and plane 12 in the base of the element 11B is equal to 86 degrees, and the antireflective covering is calculated for visible light. The angular aperture of entrance emanation is up to ±20 degrees.

Results of simulation (according to FIG. 3) are presented in Table 1, which shows the positive features of the exemplary embodiments. Benefits from application of the claimed film in displays are based on the unique features: external light is not reflected from the display in the direction close to the normal plane of the display, thus not interfering with viewing the information displayed on it. Optical simulation was performed by means of software TracePro™ v.3.2.5 (Lambda Research).

TABLE 1
The calculated features of an antireflective film, according to FIG. 3

| | The | |
|---|---|---|
| Parameter | Example 1 | The Example 2 |
| The aperture of incident light 25 (angular) | ±35° | ±20 |
| The target aperture 27 | 180° | 180 |
| Additional antireflective covering | Yes | No |
| Reflection of external beams 28 | >~0% | <6% (Lambert |
| | | light source) |
| Light transmission 25 | >70% | >80% |

One distinctive feature of the optical scheme described above is the absence of parasitic reflection of light from the front surface of the structure that increases the general contrast of the formed image.

The performed simulation (modeling) has been experimentally confirmed on the optical films made by methods of stereolithography. Films of focusing optical elements with the elements size of 200 microns have been produced. In FIG. 7, the photos presented illustrate emanation from the light-emitting diode lantern, reflected from PMMA film with the covering and without the covering. The level of the measured patch of light (reflection) from PMMA film coated by a film of optical elements is over 16 times less than the reflection from not-covered PMMA film.

The optical antireflective film addressed above may be applied in various manufacturing environments, such as LCD, organic light-emitting diode (OLED), screens for projection television and displays, plasma displays, and also antiglare and antireflective coverings for matrixes of photodetectors (CCD and CMOS).

The processing technique may be compatible to the current technologies of mass production of optical films, such as ultra-violet hardening, 3D stereo lithography, relief rolling.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

We claim:

1. An optical film, comprising:
a file of optical elements, each of the optical elements including:
a first planar surface; and
a second smoothly curved surface having a full internal reflection (FIR) and extending from the first planar surface to form a curved elongated shape, the first planar surface receiving an entrance light that exits an area of the second smoothly curved surface.

2. The optical film of claim 1, wherein the second smoothly curved surface is a combination of several smooth surfaces.

3. The optical film of claim 1, wherein the optical elements range in size from 20 micrometers to 200 micrometers.

4. The optical film of claim 1, wherein the second surface has an axis of symmetry intersecting the first and second surfaces at unique points.

5. The optical film of claim 1, wherein the second smoothly curved surface has at least one symmetry plane intersecting the first and second surfaces.

6. The optical film of claim 1, wherein the each of the optical elements includes a third planar surface disposed at an opposite end of the optical element from the first planar surface; wherein the first planar surface and the third planar surface extend in the same direction and in parallel with one another.

7. The optical film of claim 6, wherein the first and third surfaces have a circular shape when viewed from a planar surface thereof.

8. The optical film of claim 7, wherein a diameter of the third surface is smaller than a diameter of the first surface.

9. The optical film of claim 1, wherein the refraction factor of a substance from which the optical elements are made is within a range of 1 to 1.95.

10. The optical film of claim 1, wherein a top portion of the second smoothly curved second surface has a surface relief implemented by at least one of a periodic wave, a sine wave, or triangular wave and texturized to have a size within a range of 0.1 microns to 0.2 microns.

11. The optical film of claim 10, wherein the surface relief has a noise-like character.

12. The optical film of claim 1, wherein a shape of the first planar surface is at least one of round, triangular, rectangular, and hexagonal.

13. The optical film of claim 1, wherein the second smoothly curved surface has fractal structure at which low spatial frequencies work as elements on full internal reflection, and high spatial frequencies work as antireflective, antiglare layers.

14. The optical film of claim 1, wherein the optical elements are disposed on a plane of the optical film and range in size with respect to a height thereof.

15. The optical film of claim 1, wherein the optical elements are disposed on a plane of the optical film and are of equal size with respect to a height thereof.

16. The optical film of claim 1, wherein the optical elements are disposed on a plane of the optical film and vary in size with respect to a cross-section thereof.

17. The optical film of claim 1, wherein the optical elements are disposed on a plane of the optical film and are of equal size with respect to a cross-section thereof.

18. The optical film of claim 1, wherein the optical elements are disposed on a plane of the optical film and varying in size with respect to a cross-section thereof and a height thereof.

19. The optical film of claim 1, wherein the second smoothly curved surface is partially coated with a low refractive-index layer.

20. The optical film of claim 1, wherein the optical elements are made of an optical substance having a gradient of refractive index along the direction of distribution of light from the first planar surface to the second smoothly curved surface within the range of 2.0 to 1.0.

21. The optical film of claim 1, wherein the second smoothly curved surface is partially coated by multilayered interference antireflective covering.

22. The optical film of claim 1, wherein a substance, from which the optical elements are made, has polarizing properties.
